(19) United States
(12) Patent Application Publication
(10) Pub. No.: US 2011/0001652 A1
(43) Pub. Date: Jan. 6, 2011

(54) METHOD AND APPARATUS FOR GENERATING ANGULAR DECEPTION SIGNALS

(75) Inventors: Andrea De Martino, Rome (IT); Vittorio Rossi, Rome (IT)

Correspondence Address: KNOBBE MARTENS OLSON & BEAR LLP, 2040 MAIN STREET, FOURTEENTH FLOOR, IRVINE, CA, 92614, US

(73) Assignee: Elettronica S.p.A., Rome (IT)

(21) Appl. No.: 12/823,951

(22) Filed: Jun. 25, 2010

(30) Foreign Application Priority Data
Jun. 26, 2009 (IT) RM 2009 A 000330

(51) Int. Cl. G01S 7/38

(52) U.S. Cl. 342/14

(57) ABSTRACT

A method for generating and transmitting deception signals to location devices comprises use of tracking monopulse radars and associated apparatus to be installed on aircraft in particular of the rotary-blade type. The deception signals generated and sent to the tracking radar cause an angular deception, and such that, for example, the aircraft may be viewed by the radar in a direction different from the real direction.

This application claims the benefit of Italian Patent Application Number RM 2009 A 000330 filed on Jun. 26, 2009, the disclosure of which is hereby expressly incorporated by reference in its entirety and hereby expressly made a portion of this application.

### FIELD OF THE INVENTION

The present invention relates to a method and an apparatus mounted on-board aircraft, in particular of the rotary-blade type, for generating and transmitting deception signals to location devices of the monopulse radar type.

### BACKGROUND OF THE INVENTION

It is known, in the technical sector relating to weapon systems to use so-called monopulse radar systems in order to engage and track enemy platforms which the aim of striking them with missile or projectiles. These radars transmit radiofrequency electromagnetic radiation with a pulsed waveform.

The radiation backscattered by the target is processed by the radar which is able to estimate, also for a single pulse, the angular direction of origin of the target itself.

It also known that, in order to prevent engagement and tracking, aircraft are equipped with devices which are able to generate electronic counter-measures. These consist in sending signals with characteristics similar to those transmitted by the radar, superimposing frequency and/or phase and/or amplitude and/or delay modulations, able to distort the speed and distance information estimated by the radar. The so-called “bounce effect” technique is also known, this consisting in directing these deception signals towards the ground, making use of their reflection, in order to deceive the radar itself regarding the angular position of the aircraft in the plane of elevation.

This technique, which is for example described in FR 2,220,798, is unable to produce angular errors of a magnitude such as to affect interception or interruptions in tracking within the victim radar. A further known technique for provoking important errors in estimation of the direction of arrival on monopulse radars consists in the so-called “cross-eye” technique, based on providing the aircraft with a deception device having two antennae (normally situated at the ends of the wings) which, receiving the signal from the radar, transmit to the latter two signals at the same frequency as that received and such as to be in phase opposition (phase-shifted by 180°) and with a relative controlled amplitude imbalance, such as to be between 1 and 2 dB, when received by the radar.

These signals produce in the monopulse radar an error in estimation of the direction of arrival of the target. In this way the position of the aircraft appears, on the radar, as being displaced, relative to its real position in the direction of the strongest signal, but outside the body thereof; the error which can be induced depends on the distance between the two antennae and in particular is proportional to the projection of the distance between the two antennae in a plane perpendicular to the straight line which joins together the target and radar; this projection is referred to as the “cross-eye base”.

An example of those technique is described in the article “Anti monopulse Jamming Techniques” in the name of F. Neri IMOC 2001 Proceeding of the 2001 SBMO/IEEE MTT-S International, pages 45-50, Aug. 6, 2001.

Although effective, this technique nevertheless has applicational limitations arising from the fact that, in order to be able to operate correctly, it requires a relative distance between the two deception antennae such as to produce a cross-eye base of not less than 10 m.

This requirement means that said technique essentially cannot be applied to aircraft, such as helicopters, which, owing to their small dimensions in the plane perpendicular to the direction of forward movement, do not have support points useful for mounting the two deception antennae at the required distance necessary for creating the cross-eye base.

### BRIEF DESCRIPTION OF THE SEVERAL VIEWS OF THE DRAWINGS

FIG. 1 shows an example of application of the apparatus according to the present invention to a small-size aircraft, in particular a helicopter.

FIG. 2 shows in graph form the propagation factors of the signals emitted by the antennae according to the method of the present invention;

FIG. 3 shows in graph form the weighting function (WF) used in the deception method according to the present invention;

FIG. 4 shows a block diagram of the deception apparatus according to the present invention.

### DETAILED DESCRIPTION OF THE EMBODIMENTS

The technical problem which is posed, therefore, is to provide a method and an associated deception apparatus which are effective against radars of the monopulse type and can be used also on aircraft which have small dimensions in the plane perpendicular to the plane of forward movement and are therefore such that the two deception antennae cannot be installed at a distance from each other sufficient for creating a cross-eye effect.

In connection with this problem it is also required that this apparatus should be very robust, be able to manufactured at a low cost and able to be easily mounted also on already existing aircraft.

These results are achieved by a method and an apparatus according to at least some aspects of the present invention.

Further details may be obtained from the following description of a non-limiting example of embodiment of a method and an apparatus according to the present invention provided with reference to the accompanying drawings in which:

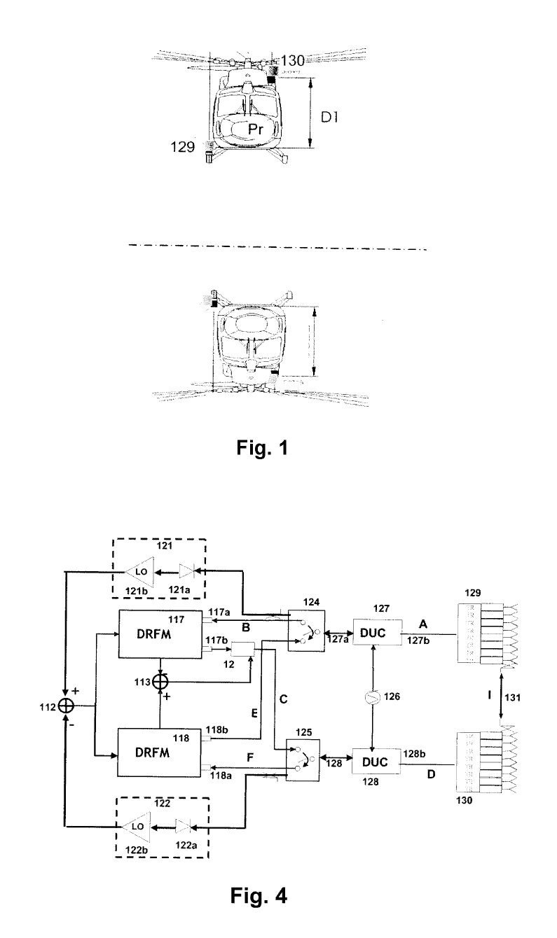

FIG. 1 shows an example of application of the apparatus according to the present invention to a small-size aircraft, in particular a helicopter.

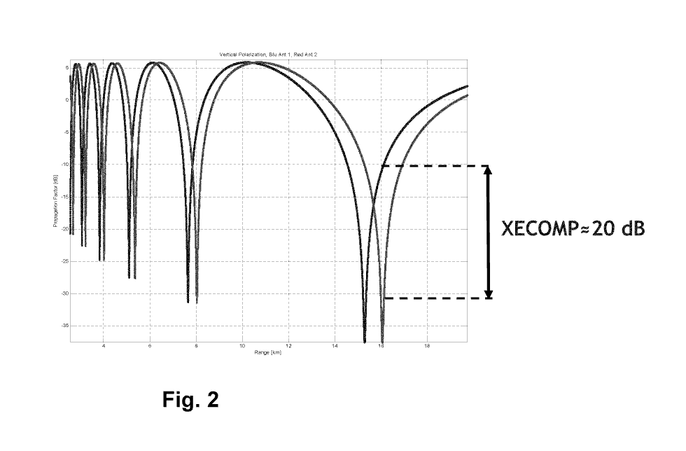

FIG. 2 shows in graph form the propagation factors of the signals emitted by the antennae according to the method of the present invention;

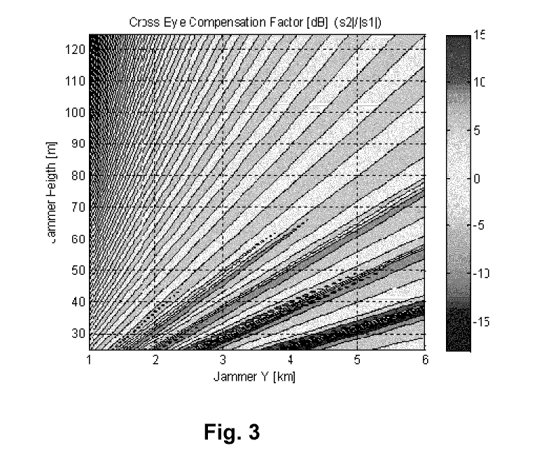

FIG. 3 shows in graph form the weighting function (WF) used in the deception method according to the present invention;

FIG. 4 shows a block diagram of the deception apparatus according to the present invention.

With reference to the accompanying FIGS. 1 to 4, according to the present invention a method is provided for the generation of angular deception signals directed towards monopulse radars by a small-size aircraft in the plane perpendicular to that of forward movement, on which a first transceiver antenna 129 and second transceiver antenna 130 are mounted at a relative distance smaller than the minimum distance (10 m) required for creating a cross-eye base.

Said method comprises the following steps:

a) arranging the two antennae 129,130 so that they have a relative height difference with respect to the ground of not less than 2 metres;

b) acquiring, by means of the first antenna 129, the signal emitted by a monopulse radar;

c) acquiring, by means of the second antenna 130, the same signal emitted by the same monopulse radar;

d) converting the signal received by the first antenna 129 from radiofrequency (RF) to intermediate frequency (IF) by means of a first Down/Up Converter (DUC) module 127;

e) converting the signal received by the second antenna 130 from radiofrequency (RF) to intermediate frequency (IF) by means of a second Down/Up Converter (DUC) module 128;

f) sending, via a first two-way switch 124, the converted IF signal received by the first antenna 129 to a first DRFM (Digital Radio Frequency Memory) circuit 117 which stores only its phase with amplitude standardized to 1;

g) sending, via a second two-way switch 125, the converted IF signal received by the second antenna 130 to a second DRFM (Digital Radio Frequency Memory) circuit 118 which stores its phase with amplitude standardized to 1;

h) measuring, by means of a first circuit 121, the amplitude of the IF signal received via the first antenna 129;

i) measuring, by means of a second circuit 122, the amplitude of the IF signal received via the first second antenna 130;

j) calculating 112 the imbalance COMP, or difference in amplitude, between the two IF signals received; (COMP=amplitude of signal received by the first DRFM 117−amplitude of the signal received by the second DRFM 118)

k) sending the difference signal COMP both to the first DRFM circuit 117 and to the second DRFM circuit 118;

l) if COMP>0, i.e. if the signal received by the first antenna 129 and therefore by the first DRFM circuit 117 is greater than the signal received by the second antenna 130 and therefore by the second DRFM circuit 118, this means that the section radar→second antenna 130 traveled along by the signal has a greater attenuation than the section radar→first antenna 129; since retransmission of the signal is crossed over, the attenuation conditions are reciprocal during transmission and reception, and the amplitudes in the devices have been standardized to 1, at the moment of retransmission, an attenuation equivalent to COMP is applied to the signal received and retransmitted by the second digital memory DRFM 118, in order to compensate for, i.e. zero the amplitude difference; then a controlled imbalance between the two signals is introduced such that the same is between 1 and 2 dB in absolute value at the moment when the signals are received by the radar;

m) if COMP<0, i.e. if the signal received by the second antenna 130 and therefore by the second DRFM circuit 118 is greater than the signal received by the first antenna 129 and therefore by the first DRFM circuit 117, this means that the section radar→first antenna 129 traveled along by the signal has a greater attenuation than the section radar→second antenna 130; since retransmission of the signal is crossed over, the attenuation conditions are reciprocal during transmission and reception, and the amplitudes in the devices have been standardized to 1, at the moment of retransmission, an attenuation equivalent to COMP is applied to the signal received and retransmitted by the first digital memory DRFM 117, in order to compensate for, i.e. zero the amplitude difference between the two signals; then a controlled imbalance between the two signals is introduced such that the same is between 1 and 2 dB in absolute value at the moment when the signals are received by the radar;

n) introduction of a phase delay 123 into the signal output from the first DRFM circuit 117 so as to cause, at the moment of reception thereof by the monopulse radar, a phase shift of 180° between the two signals transmitted by the two antennae. It should be noted that, since the two signals received and then retransmitted by the two antennae follow reciprocal paths in the air, the phase shift of the air travel is automatically compensated for, while the path followed inside the apparatus is instead different for the two signals, resulting in the introduction of a relative internal phase shift which requires a specific compensation in order to obtain exactly a phase shift of 180° between the two signals at the moment of being received by the monopulse radar. It follows that the phase delay 123 must be equal to a phase shift of 180° plus or minus the internal phase shift due to the difference between the two paths followed inside the apparatus. The value of said internal phase shift may be measured during calibration of the said apparatus.

o) sending, via the second switch 125, the output signal 117b from the first DRFM circuit 117 to the second DUC module 128 connected to the second antenna 130;

p) sending, via the first switch 124, the output signal 118b from the second DRFM circuit 118 to the first DUC module 127 connected to the first antenna 129;

q) sending the two output signals 117b, 118b from the respective DUC modules 127, 128 to the corresponding antennae 129, 130 and transmission thereof.

It has been established that, if the aircraft is flying at a sufficiently low height in relation to the distance of the radar, the method according to the present invention is able to generate effective deception signals in relation to monopulse radars, which no longer manage to maintain the locked target condition, despite the small distance between the antennae.

This result is based on the fact that the signal from an antenna mounted on a target which is flying sufficiently close to the ground is reflected by the ground and received by a monopulse radar added to the corresponding direct signal. The radar therefore receives a sum signal which has a measured intensity and direction of propagation different both from those of the direct signal alone and those of the reflected signal alone.

In particular, as shown in FIG. 2, the two signals, i.e. direct signal and reflected signal, may be in the constructive interference condition (in phase) or destructive interference condition (in phase opposition) depending on of the reciprocal phase when received by the radar; during the approach between radar and target, the constructive and destructive interference phases alternate with each other.

Since, in the case of constructive interference, the radar sees the apparent target lower than in the real position (PR), while in the case of destructive interference the radar see the apparent target higher than the real position (PR), the radar will see the approaching target fluctuating between a higher position and a lower position relative to PR.

If the ratio between the modulus of the direct signal and the modulus of the vectorial sum of the direct and reflected signal is referred to as “propagation factor”, it can be stated that the fluctuation of an apparent target is linked to the value of said propagation factor, the progression of which can be calculated and illustrated in graph form.

FIG. 2 shows two curves which represent the two propagation factors as a function of the variation in distance (X axis) between a radar and two antennae located at different heights on an aircraft (target).

Each curve corresponds to an apparent target fluctuating while approaching the radar. The distance between the two curves, for a certain value of X, increases with the increase in the difference in height of the two deception antennae and represents the temporal decorrelation during fluctuation of the two apparent targets viewed by the radar.

Consequently, by mounting on the aircraft two antennae (129,130) so that they are arranged with a difference D1 in relative height with respect to the ground which is sufficiently large, at least 2 metres, so that the signals transmitted by the first antenna 129 and by the second antenna 130 are in different and decorrelated (constructive/destructive) interference conditions when they are received by the monopulse radar, the presence of two targets which fluctuate in a decorrelated manner between a lower position and a higher position relative to the real position of the target will be simulated.

If the two signals, each the sum of the direct signal and the signal reflected on the ground, are received by the radar phase-shifted by 180° and their difference in amplitude is suitably adjusted and maintained between 1 and 2 dB, a deception similar to that obtained a cross-eye base is produced.

From the above it may be concluded that, when the signal with a larger amplitude (master antenna) is received by the radar in the constructive interference condition with its signal reflected and the signal with a smaller amplitude (slave antenna) is received by the radar in the destructive interference condition with its signal reflected, the angular error induced is directed towards the ground and therefore the radar tends to look downwards. In this condition it is possible to induce the break-lock condition.

In the opposite situation, i.e. when the master signal is in the destructive interference condition and the slave signal is in the constructive interference condition, the angular error is positive and the radar directs the beam upwards, but in such a way that the contribution of the beam reflected by the ground diminishes, allowing the radar to recover the correct position and lock again onto the target.

Consequently, in addition to keeping continuously under control the difference in amplitude of the signals transmitted by the two antennae (master and slave) so as to keep it between 1 and 2 dB when received by the radar, it is also necessary to check that this difference is always in favour of the signal which is received by the radar in constructive interference with its signal reflected by the ground.

It is therefore necessary to evaluate which of the two antennae transmits a constructive interference signal and which of them a destructive interference signal.

This interference evaluation may be performed by measuring the amplitude of the radar signal received on each antenna and comparing their values (the propagation situation is similar during reception and transmission); the difference between the two amplitudes indicates if and which of the two signals is in constructive interference and which is in destructive interference. From the above it can be understood that the points in space of the flight trajectory wherein the difference in amplitude between the signals received is high in modulus represent the point of maximum decorrelation and therefore of potential effectiveness of the technique. The effect obtained is the creation of a virtual cross-eye base which is much longer than the real base and with a length comparable to the flying height. The difference in amplitude between the signals received by the antennae is proportional to an analytical parameter known as weight function (WF). This parameter depends only on kinematic factors and on the knowledge of the orography of the terrain and may therefore be calculated a priori. The maximum modulus values of this function indicate the potentially effective spatial zones of the deception.

WF is expressed by the following relation:

$$WF = \frac{2 A ( 1 - {A}^{2} ) sin ( \overline{φ} ) sin ( \frac{Δ φ}{2} )}{{[ ( 1 - {A}^{2} ) sin ( \overline{φ} ) ]}^{2} + {[ ( 1 + {A}^{2} ) cos ( \overline{φ} ) + 2 A cos ( \frac{Δφ}{2} ) ]}^{2}}$$

wherein
A is the ratio between the amplitudes of the reflected beam and direct beam (considered to be the same for the two antennae);
φ represents the phase difference between the direct signal and the signal reflected on the ground as received by the radar;
Δφ represents the phase rotation due to the difference in height between the master antenna and slave antenna.

These parameters are calculated thus:

$$\overline{φ} = {ψ}_{r} + \frac{2 π}{λ} \frac{2 {h}_{r} {h}_{t}}{R}$$

$$Δφ = \frac{2 π}{λ} \frac{2 {h}_{r} Δ {h}_{ms}}{R}$$

wherein
hr=height of radar
ht=height of real target (PR)
R=radar−target distance
hms=difference in height between master antenna and slave antenna
ψᵣ=phase rotation due to the reflection on the ground

FIG. 4 shows in graph form the progression of the function WF calculated on flat ground.

The height of the target is shown along the y axis and the projection on the ground of the distance between radar and target is shown along the x axis. In FIG. 4 it is possible to recognise the zones where the amplitude difference between the two signals is greater (zones towards red or zones towards blue) and which indicate the positions where the deception is effective.

This information can be used for planning and guiding the trajectories within which the target aircraft must move when approaching the monopulse radar in order to render the deception effective.

Real-time measurement of the WF (which is proportional to and coincides in terms of sign with the amplitude difference of the signals received by the two master and slave antennae) allows the possibility of developing various adaptive strategies for rendering effective the cross-eye effect at a low height so as to unlock the radar from the target and/or disturb the angular tracking process.

Some examples of these strategies are as follows:
Keeping the signal transmitted in constructive interference greater (difference between 1 and 2 dB) than the signal in the destructive interference condition by suitably inverting the polarity of the imbalance applied depending on the polarity of the amplitude difference of the signals received. In this way the angular error induced is constantly downwards.
inversion of the polarity of the imbalance at a fixed frequency so as to generate oscillations in the angular tracking cycle of the radar;
sudden variation in the sign of the imbalance at the maximum points of the WF (or imbalance of the signal received) so as to cause interruption of the tracking.

According to a preferred embodiment of the method according to the invention a step for calibrating the apparatus is also envisaged, in order to equalize the phase and amplitude of the signals which travel through the apparatus in both directions and along the two following paths:

Path 1:
RX: first antenna→A→B→first DRFM 117
TX: first DRFM 117→C→D→second antenna

Path 2:
RX: second antenna→D→F→second DRFM 118
TX: second DRFM 118→E→A→second antenna

For this purpose an additional section I is inserted for direct connection between the first antenna 129 and the second antenna 130 and is passed through in both directions only during said calibration step.

In this way the two following calibration paths are obtained:

Path 1:
TXRX: first DRFM 117→C→D→I→A→B→first DRFM 117

Path 2:
TXRX: second DRFM 118→E→A→I→D→F→second DRFM 118
   so that the same signal is transmitted and received, its path embracing the section I, by the two DRFM. Inside two measuring devices the difference in amplitude (121 and 122, 112) and phase (117, 118, 113) between the transmitted signal and the received signal is verified by comparing essentially the two paths CDIAB and EAIDF; since the section I is in common, the measurement of the compensation which must be introduced into the phase of the amplitude of the two signals when the system is operative is obtained.

Still with reference to the accompanying FIGS. 1 and 2, according to the present invention an apparatus is provided for the generation of deception signals for monopulse radars by an aircraft having dimensions such that an adequate cross-eye base cannot be formed; said apparatus comprises:
a first antenna 129 and a second antenna 130 which are arranged at a relative distance less than the minimum distance (10 m) necessary for forming a cross-eye base and based on Active Phased Array technology with two-way functionality during both transmission and reception (reciprocity) and able to provide the necessary amplification both for transmission and for reception; when in operation, during flight, said antennae are mounted so as to produce a difference in relative height from the ground of at least 2 metres;
conversion means consisting for example of a first Down/Up Converter (DUC) module 127 connected to the first antenna 129 and a second Down/Up Converter (DUC) module 128 connected to the second antenna 130. Said DUC modules 127, 128 receive at their input the radiofrequency RF radar signal, captured by the respective antenna, and are able to convert the same into an intermediate frequency IF signal;
the two modules 127, 128 are also connected to a same frequency synthesizer 126 which provides the source which powers both the mixers of the two DUC modules;
a first two-way switch 124, which is connected to the input/output port 127a of the first DUC (Down/Up Converter) module 127;
a second two-way switch 125, which is connected to the input/output port 128a of the second DUC (Down/Up Converter) module 128;
a first signal measuring circuit 121 able to measure the amplitude of the signal received by the first antenna 129 and formed by a detector 121a which receives at its input the signal output to the first switch 124, followed by a logarithmic amplifier 121b in series;
a second signal measuring circuit 122 able to measure the amplitude of the signal received by the second antenna 130 and formed by a detector 122a which receives at its input the signal output to the first switch 125, followed by an associated logarithmic amplifier 122b in series;
an adder device 112 which, receiving at its input the outputs of the two said logarithmic amplifiers 121b,122b, generates a signal COMP indicating the difference between the two said signals and indentifying the amplitude imbalance between them (COMP=signal amplitude first antenna 129−signal amplitude second antenna 130);
at least one first DRFM (DRFM=Digital Radio Frequency Memory) circuit 117 able to:
receive at its input the IF signal from the first DUC module 127;
store the phase of said signal, with its amplitude standardized to 1;
receive at its input the difference signal COMP generated by the adder device 112;
if COMP<0, perform compensation of the signal received by the switch 124, applying an attenuation equal to COMP to the signal itself;
introduce a controlled amplitude imbalance of between 1 and 2 dB in absolute value into the received and compensated signal of DRFM 117;
transmit the compensated signal to the second switch 125 and then to the second DUC module 128 and to the second antenna 130;
at least one second DRFM circuit 118 able to:
receive at its input the IF signal from the second DUC module 128;
store the phase of said signal, with its amplitude standardized to 1;
receive at its input the difference signal COMP generated by the adder device 112;
if COMP>0, perform amplitude compensation of the signal received by the second DRFM circuit 118, applying an attenuation equal to COMP;
introduce a controlled amplitude imbalance of between 1 and 2 dB into the signal received and compensated by the second DRFM circuit 118;
transmit the signal to the first switch 124 and then to the first DUC module 127 and to the first antenna 129;
a device 113 able to calculate the relative phase shift between the two signals received by the respective antennae during calibration;
at least one variable phase shifter 123 able to introduce a suitable phase delay into the signal 117b output by the first DRFM circuit 117, which phase delay will be equivalent to 180° corrected by the calibration value in order to determine at the moment of reception thereof by the radar a final and overall phase-shift of 180° between the two signals transmitted by the two antennae 129, 130.

According to a preferred embodiment the apparatus also comprises an interconnecting cable 131 which is arranged between the two antennae 129, 130 in order to obtain direct connection between them for performing calibration of the apparatus.

With this configuration the operating principle of the apparatus is as follows:
the signal received by the first antenna 129 is converted to intermediate frequency IF in the associated DUC module 127 and is sent, by means of the first switch 124, to the input 117a of the first DRFM circuit 117 inside which it is stored;
the same IF signal output by the first switch 124 is also sent to the first detector 121a and from here to the first logarithmic amplifier 121b, the output of which is connected to the adder device 112;
the signal received by the second antenna 130 is converted to intermediate frequency IF in the associated second DUC module 128 and is sent, by means of the second switch 125, to the input 118a of the second DRFM circuit 118 inside which it is stored;
the same IF signal output by the second switch 125 is also sent to the second detector 122a and from here to the second logarithmic amplifier 122b, the output of which is connected to the adder device 112;
the adder device 112 calculates the amplitude difference between the two signals supplied by the respective measuring devices and sends the amplitude difference signal COMP both to the first DRFM circuit 117 and to the second DRFM circuit 118;

if COMP<0,
the first DRFM circuit 117 compensates for the difference in amplitude between the two signals received by the first DRFM circuit 117 and by the second DRFM circuit 118, attenuating the first one by a value equal to COMP received from the adder device 112, and introduces a relative imbalance into the output signal 117b from the first DRFM circuit 117 such that, at the moment of reception by the radar, the same signal has an amplitude with a value which is between 1 and 2 dB greater or smaller than that of the output signal 118b of the second DRFM circuit 118;
the compensated and amplitude-imbalanced signal supplied by the first DRFM circuit 117 is sent to the phase shifter 123 which introduces between the two signals output from the first DRFM circuit 117 and the second DRFM circuit 118 a phase shift such that they are in phase opposition (phase difference of 180°) at the moment of their being received by the radar;
the imbalanced and phase-shifted signal output by the first DRFM circuit 117 is sent to the second switch 125 which forwards it to the second DUC module 128 for transmission via the second antenna 130;
the signal output from the second DRFM circuit 118 is sent to the associated DUC module 128 for reconversion to RF and transmission to the radar via the first antenna 129;
if COMP>0,
the second DRFM circuit 118 compensates for the difference between the two signals received from the first DRFM and the second DRFM circuit, using the amplitude difference signal COMP received from the adder device 112, and introduces a relative imbalance into the signal 118b output from the second DRFM 118 such that, at the moment of reception by the radar, said signal has an amplitude with a value which is between 1 and 2 dB greater or smaller than that of the output signal 117b of the first DRFM circuit 117;
the signal from the second DRFM circuit 118 is sent to the first switch 124 which forwards it to the first DUC module 127 for reconversion to RF and transmission to the radar via the first antenna 129;
the signal output from the first DRFM circuit 117 is phase-shifted by 180° and sent to the second DUC module 129 for reconversion to RF and transmission to the radar via the second antenna 130.

As regards the above, the apparatus according to the present invention mounted on an aircraft having small dimensions in the plane perpendicular to the line of forward movement is able, by making use of the ground reflection effect and maintaining an amplitude difference of between 1 and 2 dB and a phase-shift of 180° between the signals emitted by the two antennae at the moment of their being received by the radar, to create a cross-eye condition which is effective and equivalent to that created by two deception antennae situated at a distance of several tens of metres, i.e. such as to form an effective cross-eye base.

It is therefore clear how, with the method and the associated apparatus according to the present invention, it is possible to generate and send deception signals which are based on the distortion of the angular measurement detected by tracking radars of the monopulse type, with a high degree of efficiency and reliability, and are able to be used also by aircraft which are small in size and therefore unable to mount the antennae at a minimum distance such as to provide an effective cross-eye base using conventional methods.

Although described in connection with a number of constructional forms which are currently preferred and a number of non-limiting examples of embodiment of the invention, it is understood that the scope of protection of said invention is defined by the content of the following claims.

What is claimed is:

1. A method for generating and transmitting deception signals by using an apparatus comprising a first and a second transceiver antennae which are mounted on an aircraft and are movable integrally with respect to a location device of a monopulse radar which emits a pulsed radar signal and receives deception signals emitted by the first and second transceiver antennae, comprising:
acquiring with the first and second transceiver antennae a vectorial sum of the signal emitted by the monopulse radar and a respective signal reflected by the ground;
compensating for the difference in amplitude between the signals received by the first and second transceiver antennae;
introducing a relative amplitude imbalance between the signal received by the first transceiver antenna and the signal received by the second transceiver antenna such as to produce an amplitude difference between the two signals transmitted by the two antennae of between 1 and 2 dB at the moment of their being received by the monopulse radar in combination with the respective reflected signals;
introducing a relative phase imbalance between the signal received by the first transceiver antenna and the signal received by the second transceiver antenna such as to produce a relative phase shift of 180° between the two signals transmitted by the first and second transceiver antennae at the moment of being received by the monopulse radar in combination with the respective reflected signals;
transmitting the signal received by each of the first and second transceiver antennae, wherein the phase and amplitude of the signal received by one of the first and second transceiver antennae is imbalanced by the other antenna;
arranging the first and second transceiver antennae at a relative distance less than the minimum distance necessary for providing an effective cross-eye base and with a relative height difference with respect to the ground of not less than 2 metres; and
modulating the polarity of the imbalance between the first and second transceiver antennae in order to maximise the effectiveness of the deception.

2. The method according to claim 1 further comprising:
converting the signal received by each of the first and second transceiver antennae from radiofrequency (RF) to intermediate frequency (IF) with a corresponding down/up converter (DUC) module;
sending the converted IF signal, received by the first transceiver antenna, to a first DRFM (Digital Radio Frequency Memory) circuit for storing the phase of the signal itself with an amplitude standardized to 1;
sending the converted IF signal, received by the second transceiver antenna, to a second DRFM (Digital Radio Frequency Memory) circuit for storing the phase of the signal itself with an amplitude standardized to 1;
measuring the amplitude of the IF signals received by the first transceiver antenna and by the second transceiver antenna;
calculating the amplitude difference (COMP) between the two IF signals received by the first DRFM circuit and the second DRFM circuit;
sending the amplitude difference (COMP) to the first DRFM circuit and to the second DRFM circuit;
compensating for the difference in amplitude detected between the two signals received by the first and second transceiver antennae and introducing an imbalance of between 1 and 2 dB;
applying the amplitude and phase calibration value to the two signals;
introducing a phase-shift of 180° between the two signals; and
sending said phase and amplitude-imbalanced signals output from the respective DRFM circuit to the DUC module of the other DRFM circuit and reconverting to RF.

3. The method according to claim 1, characterized in that a sign of the imbalance between the signals transmitted is determined by detecting the difference in amplitude of the signal transmitted by the monopulse radar and received by the first and second transceiver antennae.

4. The method according to claim 2, characterized in that the measurement of the difference in amplitude between the signals received by the first and second transceiver antennae comprises:
measuring the amplitude of the signal received by the first transceiver antenna and the second transceiver antenna;
calculating the amplitude difference (COMP) between the two signals received by the first transceiver antenna and the second transceiver antenna.

5. The method according to claim 4, characterized in that the relative imbalancing of the amplitude of the output signals from the two DRFM circuits is performed on either one of the signals depending on a sign of the amplitude difference (COMP) measured between them.

6. The method according to claim 1, characterized in that a flight trajectory of the aircraft is determined by a predefined weight function (WF) proportional to the amplitude difference between the signals received by the first and second transceiver antennae.

7. The method according to claim 6, characterized in that said function is defined as follows:
$$WF = \frac{2 A ( 1 - {A}^{2} ) sin ( \overline{φ} ) sin ( \frac{Δ φ}{2} )}{{[ ( 1 - {A}^{2} ) sin ( \overline{φ} ) ]}^{2} + {[ ( 1 + {A}^{2} ) cos ( \overline{φ} ) + 2 A cos ( \frac{Δφ}{2} ) ]}^{2}}$$
wherein
A is the ratio between the amplitudes of a reflected signal and a direct signal (considered to be the same for the first and second transceiver antennae).
φ represents the phase difference between the direct signal and the signal reflected on the ground as received by the radar;
Δφ represents the phase rotation due to the difference in height between the first transceiver antenna and the second transceiver antenna.

8. The method according to claim 7, characterized in that the values of φ and Δφ are expressed by the relations:
$$\overline{φ} = {ψ}_{r} + \frac{2 π}{λ} \frac{2 {h}_{r} {h}_{t}}{R}$$
$$Δφ = \frac{2 π}{λ} \frac{2 {h}_{r} Δ {h}_{ms}}{R}$$
wherein
hr=height of the radar;
ht=height of a real target (PR);
R=radar−target distance;
hms=difference in height between the first transceiver antenna and the second transceiver antenna; and
ψᵣ=phase rotation due to the reflection from the ground.

9. The method according to claim 1 further comprising calibrating the apparatus in order to equalize the phase and amplitude of the signals which travel through the apparatus in both directions.

10. The method according to claim 9, characterized in that said calibrating comprises:
directly connecting together the first transceiver antenna and the second transceiver antenna so as to form a closed-loop path, across the two antennae, of the signals received/sent by the two DRFM devices;
transmitting and receiving a respective signal from the two DRFM devices via the respective closed paths and measuring the associated attenuation and phase shift;
measuring the amplitude and phase difference between the signals transmitted and received; and
correspondingly storing the relative phase-shift in the two DRFM circuits.

11. The method according to claim 1 further comprising inverting a sign of the imbalance between the signals transmitted by the first and second transceiver antennae, guided by the measurement of the amplitude difference between the signals received by the first and second transceiver antennae, so as to induce in the radar a positive or negative angular error in the plane of elevation.

12. The method according to claim 1 further comprising inverting the signals transmitted by the first and second transceiver antennae at a fixed frequency in order to produce oscillations and interruptions in tracking during the angular tracking cycle of the radar.

13. The method according to claim 1, characterized in that said aircraft is a rotary-blade aircraft.

14. An apparatus comprising:
a first transceiver antenna and a second transceiver antenna mounted on an aircraft and movable integrally with respect to a location device of a monopulse radar, wherein said first transceiver antenna and second transceiver antenna are situated at a relative distance less than the minimum distance required to form a cross-eye base;
a first Down/Up Converter (DUC) module connected to the first transceiver antenna and a second Down/Up Converter (DUC) module connected to the second transceiver antenna, able to convert from radiofrequency (RF) to an intermediate frequency (IF) the signals received by the respective antenna during reception and vice versa during transmission;
at least one first DRFM circuit and at least one second DRFM circuit, wherein during reception each of the at least one first and one second DRFM circuits is configured to receive at their input a respective signal from the associated DUC module and a signal (COMP) representing the amplitude difference between the two signals, and wherein during transmission each of the at least one first and one second DRFM circuits is configured to emit a signal to the DUC module of the other DRFM circuit;
at least two of said DRFM circuits being able to emit, during transmission, a signal suitably amplitude-modified with respect to the other one;
a first two-way switch and a second two-way switch which are respectively arranged between output/input ports of each DUC module and said first DRFM circuit and second DRFM circuit, wherein said switches are able to send the signal received by the respective DUC module to the respective DRFM circuit during reception, and wherein said switches are able to send the signal received by the other DRFM circuit to the respective DUC module during transmission;
a first circuit for measuring the amplitude of the signal received by the first transceiver antenna;
a second circuit for measuring the amplitude of the signal received by the second transceiver antenna;
an adder device able to receive at its input the outputs of the two said amplitude measuring circuits and generate a difference signal (COMP) for them to be sent to the two said DRFM circuits;
a device able to calculate the relative phase shift between the two signals received by the respective antennae in order to perform phase calibration of the apparatus;
at least one phase shifter able to introduce a suitable variable phase delay into at least one of the output signals, from either DRFM circuit, so as to cause a controlled phase shift between the two signals.

15. The apparatus according to claim 14, characterized in that the first and second transceiver antennae are of the “Active Phased Array” type with two-way transmission/reception functionality.

16. The apparatus according to claim 14, characterized in that the first and second transceiver antennae are arranged with a relative height difference of at least 2 metres with respect to the ground.

17. The apparatus according to claim 14, characterized in that the amplitude-modified signal output from said at least one of the two DRFM circuits has an amplitude with a value between 1 and 2 dB greater than that of the signal output from the other DRFM circuit at the moment of reception of the two signals by the radar.

18. The apparatus according to claim 14, characterized in that the phase delay, which is introduced into one of the two signals, is such as to cause a phase shift of 180° at the moment of reception of the two signals by the radar.

19. The apparatus according to claim 18, characterized in that said phase delay, which is introduced into either one of the two signals, is equal to 180° plus the relative phase shift calculated during calibration.

20. The apparatus according to claim 14, characterized in that the output signal from the first DRFM circuit is sent to the second transceiver antenna by the respective DUC module.

21. The apparatus according to claim 19, characterized in that the output signal from the second DRFM circuit is sent to the first transceiver antenna via the associated DUC module.

22. The apparatus according to claim 14, characterized in that said first and second amplitude measurement circuits comprise at least one detector and at least one logarithmic amplifier arranged in series.
